(19) United States
(12) Patent Application Publication
(10) Pub. No.: US 2022/0186679 A1
(43) Pub. Date: Jun. 16, 2022

(54) PRESSURE BOOST SYSTEM

(71) Applicant: EATON INTELLIGENT POWER LIMITED, Dublin 4 (IE)

(72) Inventors: Arindam SANTRA, P.S. Purba Jadavpur, Kolkata, West Benga (IN); Umar FAROOQ, Okemos, MI (US)

(73) Assignee: EATON INTELLIGENT POWER LIMITED, Dublin 4 (IE)

(21) Appl. No.: 17/425,702

(22) PCT Filed: Feb. 6, 2020
(86) PCT No.: PCT/EP2020/025054

§ 371 Date: Jul. 23, 2021

(30) Foreign Application Priority Data
Feb. 8, 2019 (IN) 201911005013

(51) Int. Cl. F02G 1/043; F01B 11/00; F01K 25/10; F04B 19/00; F04B 49/14; F04B 9/133; F04B 9/137; F02G 1/044; F02M 59/10

(52) U.S. Cl. CPC F02G 1/0435; F01B 11/001; F01K 25/103; F04B 19/003; F02G 2280/50; F04B 9/133; F04B 9/1378; F02G 1/044; F02M 59/107; F04B 49/14

(57) ABSTRACT

Boosting systems for converting heat into useable work. The systems can be modular with the ability to add boost chambers as modules to a base design. The systems can have driving chambers with volumes that are mechanically adjustable.

Systems for converting low grade heat into usable work have been developed (e.g., see PCT International Publication No. WO 2018/093641).

### BACKGROUND

### Summary

In general terms the present disclosure is directed to boosting systems for effectively converting heat into useable work. In certain examples, the systems can be modular with the ability to add boost chambers to a base design. In certain examples, the systems can have driving chambers with volumes that are mechanically adjustable. In certain examples, sensors can be used to continuously monitor chamber size and/or piston position to provide system feedback. In certain examples, sensors can be used to sense end of travel positions for pistons to provide system feedback. In certain examples, the systems can have cushioning to absorb end of stroke impacts of the pistons. The cushioning can be fixed or externally adjustable.

A variety of additional aspects will be set forth in the description that follows. The aspects relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The following drawings are illustrative of particular embodiments of the present disclosure and therefore do not limit the scope of the present disclosure. The drawings are not necessarily to scale and are intended for use in conjunction with the explanations in the following detailed description.

FIG. 1 is a perspective view of a boost system in accordance with the principles of the present disclosure;

FIG. 2 is a cross-sectional view cut lengthwise through the boost system of FIG. 1;

FIG. 3 is a cross-sectional view showing a boost system in accordance with the principles of the present disclosure with additional boost chamber modules added in an in-line/co-axial arrangement;

FIG. 4 is a cross-sectional view showing a boost system in accordance with the principles of the present disclosure with additional boost chamber modules added in a parallel/stacked arrangement;

FIG. 5 is a perspective view of an alternative boost system in accordance with the principles of the present disclosure that has a four lug configuration and has flat upper and lower interfaces adapted to facilitate stacking of multiple boost systems;

FIG. 6 is a perspective view of a boost system with piston cushioning; and

FIG. 7 is cross-sectional view showing a boost system with piston linear position sensing.

FIG. 8 is a further view of the boost system of FIG. 7.

### DETAILED DESCRIPTION

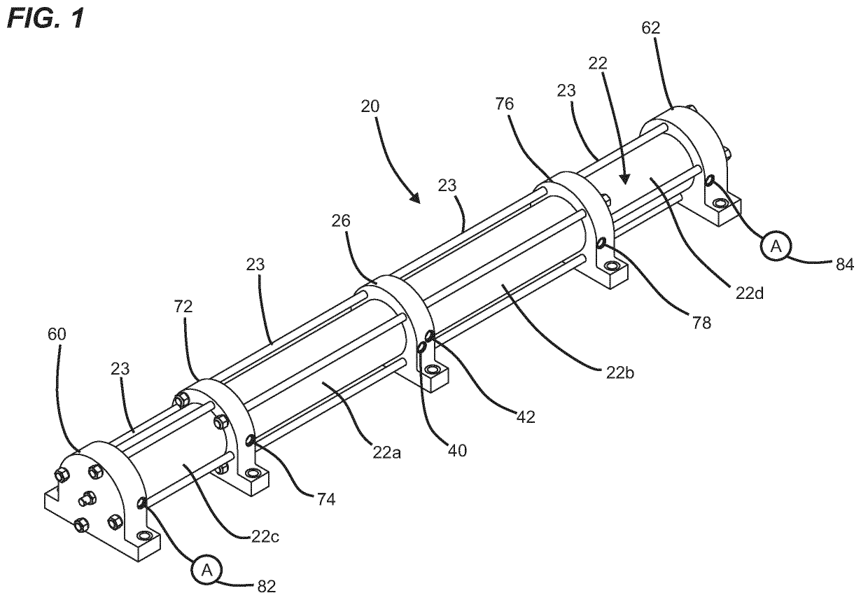

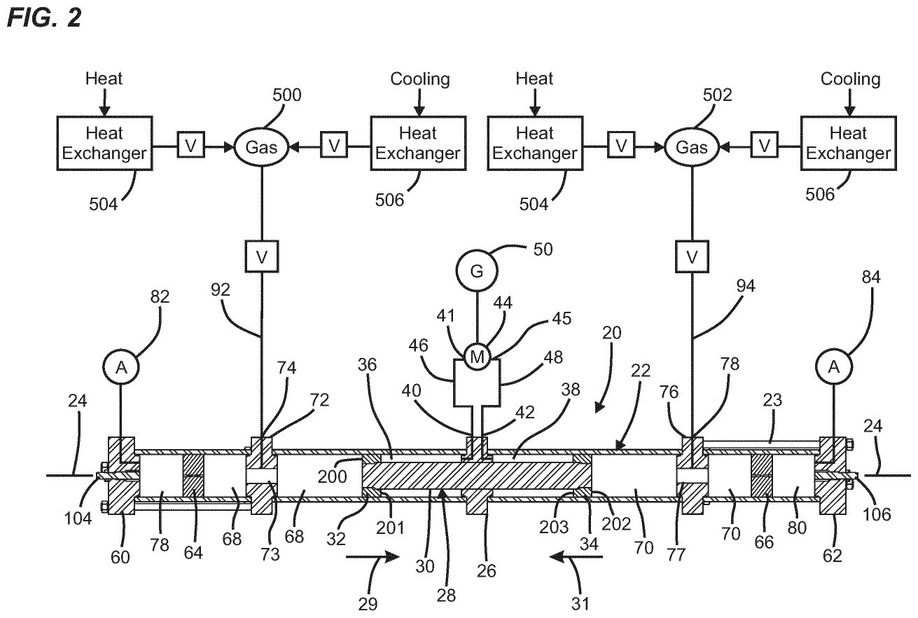

FIGS. 1 and 2 depict a pressure boosting system 20 in accordance with the principles of the present disclosure. In certain examples, the pressure boosting system 20 can be incorporated into a system for efficiently converting relatively low grade heat into usable work. Example systems for converting low grade heat into usable work are disclosed by International Publication No. WO2018/093641, which is hereby incorporated by reference in its entirety.

The pressure boosting system 20 of FIGS. 1 and 2 is depicted as a multi-chamber boosting device including a plurality of separate chambers. As depicted at FIG. 1, the pressure boosting system 20 has an in-line arrangement in which the plurality of chambers are provided with an elongate cylinder 22 that extends along an axis 24. As described below, the cylinder 22 is divided into the plurality of chambers by structures such as piston heads and one or more cylinder heads. The cylinder 22 can include a plurality of cylinder segments 22a, 22b, 22c and 22d retained together by fasteners 23 (e.g., bolts) that interconnect cylinder heads of the system. The cylinder heads can be positioned between the segments 22a and 22b, between the segments 22a and 22c, between the segments 22b and 22d, and at outer ends of segments 22c and 22d. The cylinder heads can include positive stops mounted thereto or can themselves form positive stops for limiting ranges of movement of pistons/piston heads within the cylinder 22.

Referring to FIG. 2, the pressure boosting system 20 includes a cylinder head 26 positioned at a central region of the cylinder 22. The cylinder head 26 supports a piston 28 including a piston rod 30. The piston 28 is configured to reciprocate back and forth along the axis 24 relative to the cylinder head 26. The piston 28 further includes first and second piston heads 32, 34 mounted at opposite ends of the piston rod 30. A first hydraulic fluid chamber 36 is defined between the first piston head 32 and the cylinder head 26, and a second hydraulic fluid chamber 38 is defined between the second piston head 34 and the cylinder head 26. The cylinder head 26 is configured to hydraulically isolate the first and second hydraulic fluid chambers 36, 38 from one another within the cylinder 22. The cylinder head 26 includes a first port 40 in fluid communication with the first hydraulic fluid chamber 36 and a second port 42 in fluid communication with the second hydraulic fluid chamber 38. It will be appreciated that the first and second hydraulic fluid chambers 36, 38 are adapted to receive a hydraulic fluid (e.g., a liquid) such as a hydraulic oil. As shown at FIG. 2, the first port 40 is shown fluidly connected to a first side 41 of a hydraulic motor 44 by a first flow line 46. The second port 42 is shown fluidly connected to a second side 45 of the hydraulic motor 44 by a second flow line 48. The hydraulic motor 44 is shown mechanically connected to a generator 50 such as an electrical generator 50.

The flow lines 46, 48 and the motor 44 form a closed hydraulic circuit or flow path that extends between the first and second chambers 36, 38. When the hydraulic piston 28 moves in a first direction 29 (e.g., a rightward direction) relative to the cylinder head 26, hydraulic fluid flows through the hydraulic circuit from the first chamber 36 to the second chamber 38. When the hydraulic piston 28 moves in a second direction 31 (e.g., a leftward direction) relative to the cylinder head 26, hydraulic fluid flows through the hydraulic circuit from the second chamber 38 to the first chamber 36. Hydraulic flow through the hydraulic circuit drives rotation of the motor 44 which drives the generator 50 causing the generator 50 to generate electricity. In other examples, an open hydraulic system having a reservoir can be used. It will be appreciated that boosted pressure from the chambers 36, 38 can be used to drive any type of hydraulic component and that the depicted motor and generator configurations are provided as a general example, but other arrangements can be used as well.

The pressure boosting system 20 also includes first and second end cylinder heads 60, 62 positioned at opposite ends of the cylinder 22. A third piston head 64 is positioned between the first end cylinder head 60 and the first piston head 32, and a fourth piston head 66 is positioned between the second end cylinder head 62 and the second piston head 34. A first gas chamber 68 is defined within the cylinder 22 between the third piston head 64 and the first piston head 32. A second gas chamber 70 is defined between the fourth piston head 66 and the second piston head 34. A first intermediate cylinder head 72 is provided within the first gas chamber 68. The first intermediate cylinder head 72 divides the first gas chamber 68 into a first portion between the right side of the first intermediate cylinder head 72 and the piston head 32 and a second portion between the left side of the first intermediate cylinder head 72 and the piston head 64. The first intermediate cylinder head 72 defines a through-opening 73 that provides fluid communication between the first and second portions of the first gas chamber 68. The first intermediate cylinder head 72 defines a port 74 in fluid communication with the first gas chamber 68 and also functions as a stop for stopping rightward movement of the third piston head 64 as well as a stop for limiting leftward movement of the piston 28. Cushioning can be provided for softening impact loading/stress between the piston head 32 and the first intermediate cylinder head 72. A second intermediate cylinder head 76 is provided within the second gas chamber 70. The second intermediate cylinder head 76 defines a port 78 in fluid communication with the second gas chamber 70. Additionally, the second intermediate cylinder head 76 functions as a stop for stopping leftward movement of the fourth piston head 66 as well as a stop for limiting rightward movement of the piston 28. Cushioning can be provided for softening impact loading/stress between the piston head 34 and the second intermediate cylinder head 74. The second intermediate cylinder head 76 divides the second gas chamber 70 into a first portion between the left side of the second intermediate cylinder head 76 and the piston head 34 and a second portion between the right side of the second intermediate cylinder head 76 and the piston head 666. The second intermediate cylinder head 76 defines a through-opening 77 that provides fluid communication between the first and second portions of the second gas chamber 70.

The pressure boosting system 20 further includes a third hydraulic fluid chamber 78 positioned between the third piston head 64 and the first end cylinder head 60, and a fourth hydraulic fluid chamber 80 positioned between the fourth piston head 66 and the second end cylinder head 62. The third hydraulic fluid chamber 78 is in fluid communication with a first hydraulic fluid accumulator 82 while the fourth hydraulic fluid chamber 80 is in fluid communication with a second hydraulic fluid accumulator 84.

The first piston head 32 has a first axial surface area 200 facing towards the first gas chamber 68 and a second axial surface area 201 facing toward the first hydraulic fluid chamber 36. Because of the presence of the piston rod 30, the second axial surface area 201 is substantially smaller than the first axial surface area 200. Thus, due to this difference in axial surface area, pressure applied to the first piston head 32 by the first gas chamber 68 is boosted/amplified at the first hydraulic fluid chamber 36. Similarly, the second piston head 34 has a first axial surface area 202 that faces toward the second gas chamber 70 and a second axial surface area 203 that faces toward the second hydraulic fluid chamber 38. Because of the presence of the piston rod 30, the second axial surface area 203 is substantially smaller than the first axial surface area 202. Thus, pressure applied to the second piston head 34 by the second gas chamber 70 is boosted/amplified at the second hydraulic fluid chamber 38. This boosting action allows higher boosted working pressures to be provided to the motor 44 for driving the generator 50.

As shown at FIG. 2, the first and second end cylinder heads 60, 62 can include adjustable piston stops 104, 106 (e.g., threaded stops) that can be moved (e.g., threaded) relative to the end cylinder heads 60, 62 to adjust the distance the piston stops 104, 106 project into the fluid chambers 78, 80. The piston stops 104, 106 control the stopping positions of the pistons 64, 66 within the cylinder 22 as the pistons 64, 66 move toward their respective end cylinder heads 60, 62. In this way, the volumes of the gas chambers 68, 70 can be adjusted. For example, the piston stop 104 allows for the adjustment of the volume of the gas chamber 68 when the piston head 64 is in the left-most position (i.e., against the stop 104 or the first end cylinder head 60) and the piston 28 is in the left-most position (i.e., the piston head 32 is against the intermediate cylinder head 72). Similarly, the piston stop 106 allows for the adjustment of the volume of the gas chamber 70 when the piston head 66 is in the right-most position (i.e., against the stop 106 or the first end cylinder head 62) and the piston 28 is in the right-most position (i.e., the piston head 34 is against the intermediate cylinder head 76).

Referring still to FIG. 2, the system is configured to alternatingly provide heated/pressurized gas (e.g., carbon dioxide) to the gas chambers 68, 70 to drive the piston 28 back and forth in the cylinder 22 such that pressurized hydraulic fluid with boosted hydraulic pressure is directed to the motor 44 to drive rotation of the motor 44 and the generator 50. It will be appreciated that a variety of valve arrangements or other configurations can be used to alternatingly provide the heated/pressurized gas the gas chamber 68, 70. In certain examples, when heated gas is used to increase pressure within one of the chambers 68, 70, cooled gas can be used to reduce pressure in the other of the chambers 68, 70. In certain examples, the heated gas provided to the gas chambers 68, 70 can be heated by a source of relatively low grade heat (e.g., via a heat exchanger).

FIG. 2 shows one example valve arrangement for alternating the provision of heated gas to the gas chambers 68, 70. Valves V can be opened and closed to alternatingly place the gas chambers 68, 60 in fluid communication with a source of heated/pressurized gas and a source of cooled/de-pressurized gas. As shown at FIG. 2, sources of gas 500, 502 can be heated and cooled by corresponding heat exchangers 504, 506.

In operation of the system 20, the boost system can initially be in an arrangement in which the piston 28 is in the leftmost position (e.g., with the piston head 32 stopped against the right side of the first intermediate cylinder head 72), the piston head 64 is in the rightmost position (e.g., stopped against the left side of the first intermediate cylinder head 72), the piston 66 is in the leftmost position (against the right side of the second intermediate cylinder head 76). In this arrangement, the chamber 68 is de-pressurized and the chamber 70 is pressurized. At this point, the first gas chamber 68 is placed in fluid communication with heated/pressurized gas from the source of gas 500 causing the piston head 64 to move to the left thereby forcing hydraulic fluid back into the accumulator 82. Once the piston head 64 reaches its leftmost position, fluid communication between the source of heated/pressurized gas and the first gas chamber 68 is terminated and the second gas chamber 70 can be placed in fluid communication with a source of cooled gas to de-pressurize the second gas chamber 70. Pressure within the first gas chamber 68 which acts on the surface 200 of the piston head 32 then causes the piston 28 to move to the right thereby causing hydraulic fluid having boosted hydraulic pressure to be forced from the chamber 36 through the motor 44 to drive rotation of the motor 44. The hydraulic fluid flows to the chamber 38 after passing through the motor 44. As the piston 28 moves to the right, the piston head 64 also moves to the right via pressure from the accumulator 82 such that the volume of the first gas chamber 68 maintains constant so that the gas pressure in the first gas chamber 68 which acts on the piston head 32 remains constant or relatively constant. The piston 28 is preferably driven a full stroke length to the right by the pressure in the first gas chamber 68 until the piston head 32 stops at the left side of the cylinder head 26. The piston head 64 is concurrently driven a full stroke length to the right by the accumulator 82.

Once the piston 28 traverses a full stroke length to the right, the piston head 32 is directly at the left side of the second intermediate cylinder head 76 and the piston head 66 is directly at the right side of the second intermediate cylinder head 76. The second gas chamber 70 is then placed in fluid communication with heated/pressurized gas from the source of gas 502 causing the piston head 66 to move to the right thereby forcing hydraulic fluid back into the accumulator 84. Once the piston head 66 reaches its rightmost position, fluid communication between the source of heated/pressurized gas and the second gas chamber 70 is terminated and the first gas chamber 68 can be placed in fluid communication with a source of cooled gas to de-pressurize the first gas chamber 68. Pressure within the second gas chamber 70 then acts on the area 202 of the piston head 34 causing the piston 28 to move to the left which causes hydraulic fluid having boosted hydraulic pressure to be forced from the chamber 38 through the motor 44 to drive rotation of the motor 44. The hydraulic fluid flows to the chamber 36 after passing through the motor 44. As the piston 28 moves to the left, the piston head 66 also moves to the left via pressure from the accumulator 84 such that the volume of the second gas chamber 70 remains constant so that the gas pressure in the second gas chamber 70 which acts on the piston head 34 remains constant or relatively constant. The piston 28 is preferably driven a full stroke length to the left by the pressure in the second gas chamber 70 until the piston head 32 stops at the right side of the cylinder head 26. The piston head 66 is concurrently driven a full stroke length to the left by the accumulator 84. Once the piston 28 traverses though its full leftward stroke, the process is repeated by again pressurizing the first gas chamber 68. The alternating pressurization cycle is continuously repeated to drive rotation of the motor 44 and generate electricity at the generator 50.

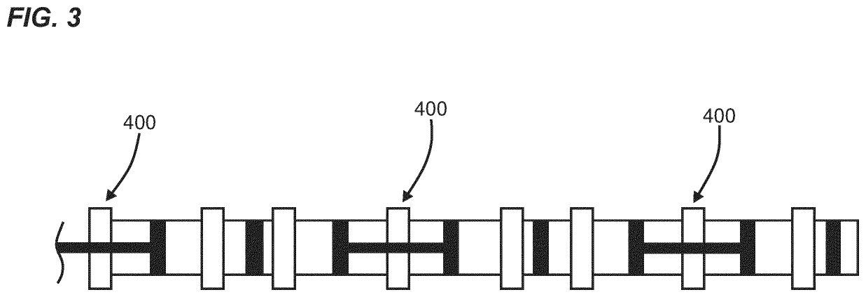

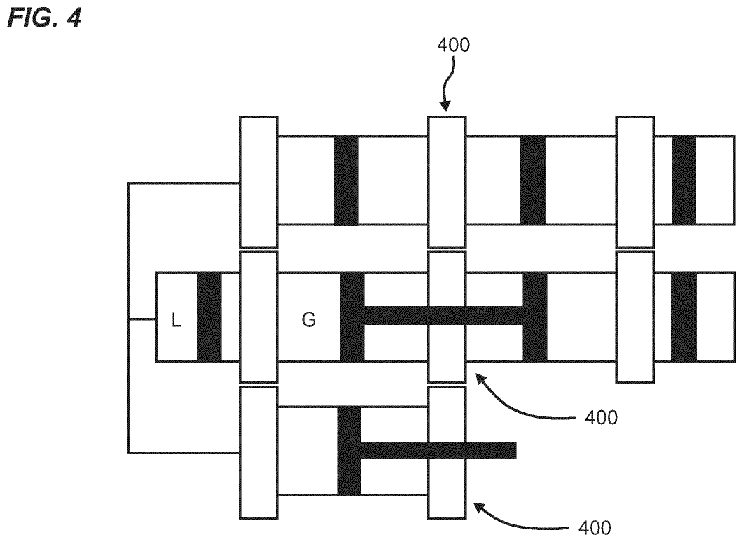

It will be appreciated that booster arrangements in accordance with the principles of the present disclosure can have modular configurations which allows for systems having with different chamber counts and configurations to be readily manufactured to provide customized systems to for particular applications. Each section of the system can have a modular configuration that allows the various modules/sections to be coupled together in a building-block type manner (e.g., the sections can be joined together by fasteners 23 or the like). In certain examples, the arrangements can provide systems that are easy to assemble and easy to maintain. The systems can have relatively small sized components thereby facilitating transport and part replacement. Based on the working requirements of a given application, sections of cylinder can be added or subtracted to increases or decrease the number of boost chambers utilized. FIG. 3 schematically shows a system having a plurality of boost chamber modules 400 (i.e., modules each having one of the double headed pistons 28, cylinder heads 26 and corresponding section of the cylinder 22) arranged in an in-line (e.g., series or co-axial) configuration. FIG. 4 schematically shows additional boost chamber modules 400 added in a stacked (e.g., parallel) configuration. Modules corresponding to one or more of each of the gas chambers 68, 70 and chambers 78, 80 are also provided in the systems. The systems can be hydraulically and pneumatically configured so that the various modules operate in concert with one another. The additional boost chamber modules can increase the working surface area of the system. The number of chambers can be increased or decreased based on volume of flow requirements/adjustments.

Sensors can be provided for one or all of the pistons and/or chambers to provide for continuous location feedback and/or end of travel feedback. In certain examples, the volume of the driving chambers (e.g., gas chambers 68, 70) can be externally mechanically adjustable (e.g., by adjusting the stop positions of the pistons 64, 66). Stroke/piston sensing technology is disclosed by U.S. Pat. No. 9,624,773, which is hereby incorporated by reference in its entirety.

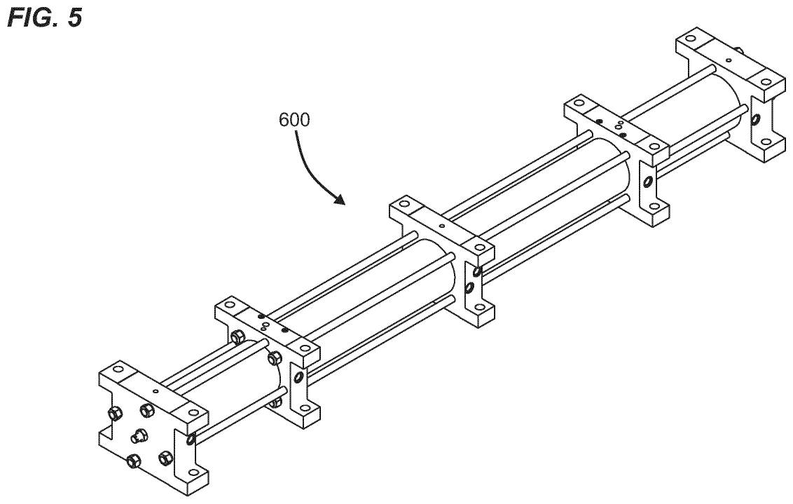

FIG. 5 shows another system 600 in accordance with the principles of the present disclosure which has the same base design as the system 20, except the system has four attachment lugs at each cylinder head and has a flat configuration suitable for stacking as shown at FIG. 4.

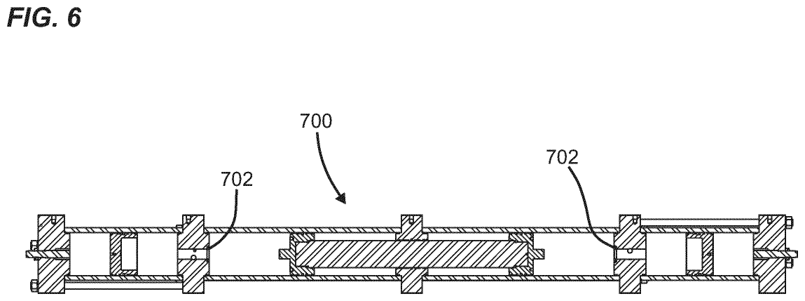

FIG. 6 shows another system 700 in accordance with the principles of the present disclosure which has the same basic design as the system 20, except the system includes piston cushioning features 702.

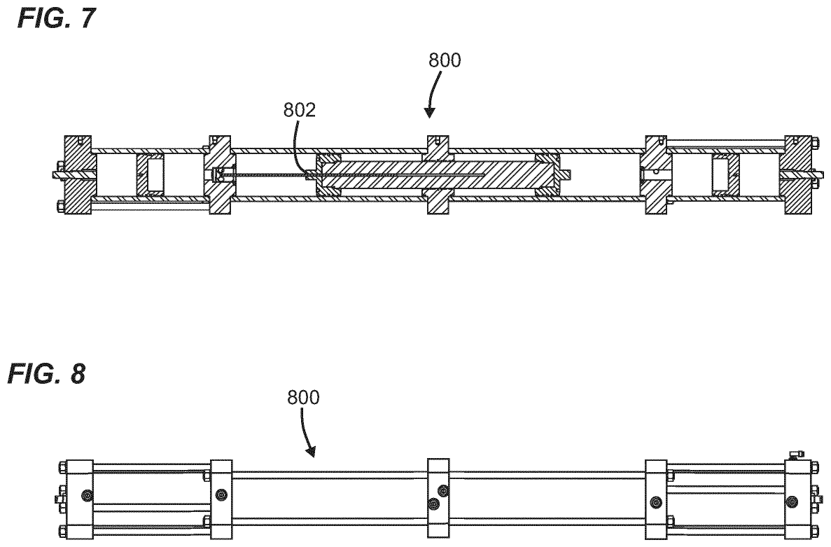

FIGS. 7 and 8 show another system 800 in accordance with the principles of the present disclosure which has the same basic design as the system 20, except the system includes piston sensing features 802.

1. A boost system comprising:
a cylinder head;
a piston including a piston rod that extends through the cylinder head, the piston including first and second piston heads positioned on opposite sides of the cylinder head, wherein a first hydraulic chamber is defined between a rod side of the first piston head and the cylinder head and wherein a second hydraulic chamber is defined between a rod side of the second piston head and the cylinder head;
a first gas chamber defined in part by a non-rod side of the first piston head and a second gas chamber defined in part by a non-rod side of the second piston head;
a third hydraulic chamber separated from the first gas chamber by a third piston head, wherein a first side of the third piston head is exposed to the first gas chamber and wherein a second side of the third piston head is exposed to the third hydraulic chamber;
a first hydraulic accumulator in fluid communication with the third hydraulic chamber;
a fourth hydraulic chamber separated from the second gas chamber by a fourth piston head, wherein a first side of the fourth piston head is exposed to the second gas chamber and wherein a second side of the fourth piston head is exposed to the fourth hydraulic chamber;
a second hydraulic accumulator in fluid communication with the fourth hydraulic chamber,
wherein gas pressure in the first gas chamber causes the piston to move in a first direction causing hydraulic fluid having boosted pressure to be output from the first hydraulic chamber, wherein when the piston moves in the first direction the first hydraulic accumulator causes the third piston head to also move in the first direction such that gas pressure is maintained in the first gas chamber; and
wherein gas pressure in the second gas chamber causes the piston to move in a second direction causing hydraulic fluid having boosted pressure to be output from the second hydraulic chamber, wherein when the piston moves in the second direction the second hydraulic accumulator causes the fourth piston head to also move in the second direction such that gas pressure is maintained in the second gas chamber.

2. The boost system of claim 1, further comprising a cylinder which at least partially defines the first hydraulic chamber, the second hydraulic chamber, the third hydraulic chamber, the fourth hydraulic chamber, the first gas chamber and the second gas chamber, and wherein the first, second, third and fourth piston heads are axially moveable within the cylinder.

3. The boost system of claim 1, further comprising adjustable stops for limiting a range of movement of the third and fourth piston heads to adjust the first and second gas chambers.

4. The boost system of claim 3, wherein the stops are mounted in end caps which define ends of the third and fourth hydraulic chambers

5. The boost system of claim 4, wherein the stops are axially moveable relative to the end caps during adjustment, and can be set in a locked position once adjusted.

6. The boost system of claim 1, wherein the system includes a modular configuration that allows for the addition of additional ones of the first and second hydraulic chambers and additional ones of the first and second gas chambers.

7. The boost system of claim 6, wherein the modules can be added in a linear series configuration.

8. The boost system of claim 6, wherein the modules can be added in a parallel configuration.

9. The boost system of claim 1, wherein when the piston moves in the first direction the third piston head also moves in the first direction via pressure from the first accumulator to maintain the first gas chamber at a constant volume as the piston move in the first direction, and wherein when the piston moves in the second direction the fourth piston head also moves in the second direction via pressure from the second accumulator to maintain the second gas chamber at a constant volume as the piston moves in the second direction.

10. The boost system of claim 1, wherein the system includes a first intermediate cylinder head that divides the first gas chamber into a first portion between the first intermediate cylinder head and the first piston head and a second portion between the first intermediate cylinder head and the third piston head, and wherein the system includes a second intermediate cylinder head that divides the second gas chamber into a first portion between the second intermediate cylinder head and the second piston head and a second portion between the second intermediate cylinder head and the fourth piston head.

11. The boost system of claim 10, wherein the first intermediate cylinder head stops movement of the third piston head in the first direction, and wherein the second intermediate cylinder head stops movement of the fourth piston head in the second direction.

12. The boost system of claim 1, further comprising first and second positive stops for each of the third and fourth piston heads for limiting the movement of the third and fourth piston heads in the first and second directions.

13. The boost system of claim 12, wherein at least one of the positive stops for each of the third and fourth piston heads is adjustable.

14. The boost system of claim 12, wherein one of the positive stops for the third piston head is at an intermediate location along the first gas chamber, and wherein one of the positive stops for the fourth piston head is at an intermediate location along the second gas chamber.

15. The boost system of claim 1, further comprising piston cushioning for cushioning stop positions of the piston.

16. The boost system of claim 1, further comprising an end of stroke switch or a linear position sensor for the piston.
